(19) United States
(12) Patent Application Publication
(10) Pub. No.: US 2020/0337250 A1
(43) Pub. Date: Oct. 29, 2020

(54) Method and Apparatus For Growing a Cannabis Plant

(71) Applicant: Craig Glover, Hamilton (CA)

(72) Inventor: Craig Glover, Hamilton (CA)

(21) Appl. No.: 16/852,802

(22) Filed: Apr. 20, 2020

Related U.S. Application Data
(60) Provisional application No. 62/837,766, filed on Apr. 24, 2019.

(51) Int. Cl. A01G 9/12

(52) U.S. Cl. CPC A01G 9/12; A01G 7/045

(57) ABSTRACT

The present concept is a method of growing a Cannabis plant includes the steps of growing a main stem which is known as an apical meristem of a Cannabis plant to a height of 12 to 24 inches above the soil. Train the plant by trimming uppermost leaves of the apical meristem which results in the growth of at least three main upper branches emerging proximate the top of the plant. Apply a light cycle to stimulate a vegetative growth phase. Lower a screen onto the upper branches such that the upper branches support the weight of the screen, wherein applying the weight of the screen onto the upper branches increases the vigor of the plant and trains the branches to grow horizontally radially outwardly from the apical meristem. Manually position branches under the screen so that the branches are directed radially away from the apical meristem along a screen bottom surface and towards an outer periphery of the screen.

### FIELD OF THE INVENTION

The present concept relates generally to a method and apparatus for growing plants, and more particularly relates to a method and apparatus for growing a Cannabis plant.

### BACKGROUND OF THE INVENTION

The Cannabis plant goes through a number of different growth phases which may be classified as follows:

a. Germination or cloning
b. Vegetative growth phase
c. Reproductive growth phase or sometimes called budding or flowering growth phase
d. Harvest and curing

It is well known that a Cannabis plant is initiated by germination from seed or by cloning using branches and leaves of an existing plant. Normally when a plant reaches four to six inches of height the seedling is transplanted into a larger pot.

During the vegetative phase the plant is allowed to develop a strong and healthy main stem and branch structure. To grow the plant during the vegetative phase, artificial lights are lit approximately 18 hours a day with bulbs that emit the blue spectrum of light.

The reproductive phase also sometimes called the budding or flowering phase is the period of growth where the flowers buds are developed. Artificial lighting during the reproductive phase is usually lit for a period of 12 hours on and for a period of 12 hours off.

Harvesting usually refers to cutting down and drying the plants once they have finished their reproductive cycle.

This is a very brief snapshot of the growing stages of the Cannabis plant. The present concept is not concerned with the germination/cloning phase or the harvest/curing phase but is most concerned with the vegetative phase and the reproductive phase sometimes also referred to as the budding or flowering phase.

During the vegetative phase in particular and to a lesser degree in the reproductive phase plant training is used to manipulate the growth of the plant.

With respect to the Cannabis plant the development and growth of the main stem which is also called the dominant apical meristem or simply the apical meristem of the plant dictates the general growth pattern developed by the Cannabis plant in the wild. The apical meristem is the main stem or shoot or dominant central stem of a plant where plant growth originates. Growth of the plant is most intense at the apical meristem such that secondary shoots originating from the apical meristem grow less rapidly then the apical meristem does. Traditionally in the wild many plants such as but not limited to those within the Cannabis family have a single dominant apical meristem that creates a Christmas tree like triangular growth pattern. This pattern optimizes the plants ability to absorb light in the wild from the suns exposure as it arcs across the sky during the course of a day. This growth pattern however is inefficient when plants are cultivated indoors and when artificial overhead stationary lights are used because of the positioning of the light source and due to the fact that the light source is stationary rather than moving as the sun does across the sky. An artificial stationary light source therefore does usually not provide light to all parts of the plant resulting in uneven growth and inefficient use of the artificial lighting that is available.

Currently in the industry techniques attempt to induce horizontal or lateral growth of the plant over vertical growth in such a manner that the plant may better utilize the stationary overhead artificial light that is generated indoors. In order to induce horizontal or transverse growth of the branches of the plant, various training techniques are employed some of which are listed here below.

US Patent Application 2017/0188524 was published Jul. 6, 2017 under the title ‘Plants Support and Growth Directing Apparatus and Method of Use’ filed by Christopher Di Muro and Lindsay Di Muro under application number 15/338-359 on Oct. 29, 2016. This application provides an extensive discussion of various training techniques that are used to manipulate the growth of the plant and I have reproduced some portions of this discussion from that application for easy reference here-in.

US Patent Application 2017/0188524 indicates that often intentional damage or stress is imparted onto plants in order to stimulate a growth and healing response that will ultimately increase the plant yield and facilitate the training of the plant. Training of plants can include techniques such as super cropping, high stress training, low stress training, stem cracking, topping, bending, tying, pruning, thinning, and generally trimming of the plant in strategic locations.

Us Patent Application 2017/0188524 indicates that super cropping is also sometimes referred to as high stress training or pinching which involves firmly pinching the apical meristem of the plant so as to damage the apical meristem tissue to cause lower limbs of the plant to grow more rapidly while the pinched tissue heals. This usually causes the plants growth pattern to become shorter and more horizontal resulting in increased light absorption by the plant from a stationary overhead artificial light source.

US Patent Application 2017/0188524 indicates that topping requires removing the top of the main shoot or apical meristem to transfer apical dominance which is the tendency of the apex to grow most rapidly to the shoots emanating from the nodes immediately beneath the pruning cut. Topping can be repeated in different parts of the plant and is used to again train the plant and to grow horizontally into a bush having more secondary shoots rather than vertically through the apical meristem. This technique tries to convert the traditional Christmas tree like shape to become flatter at the top and form more of a martini glass shape with a flatter and more horizontal top. This shape allows for more horizontal surface area of the plant which increases light absorption of the plant from stationary artificial light sources.

US Patent Application 2017/0188524 indicates in paragraph 20 of the application which was published on Jul. 6, 2017 that “The Improved Plant Support and Training Apparatus should be configured to spread out the plants limbs and branches to improve airflow and light to the interior of the plant and to support those parts of the plants including branches and limbs that are likely to break or otherwise be damaged by the weight of the plant part or the produce growing from the plant part.”

To the best of the inventor's knowledge, training techniques that have been used to date all are concerned with supporting the plant branches as indicated in paragraph 20 of US Patent Application US2017/0188524 and that techniques such as tying, topping, pruning, and bending are all techniques that are used to ultimately support the parts of the plant and normally include some kind of support device not unlike the one that is described in US Patent Application 2017/0188524.

### SUMMARY OF THE INVENTION

The applicant here-in has discovered new training techniques for Cannabis plants that are not, to the best of the applicant's knowledge, disclosed or known in the prior art. Rather than attempting to support the plant using various support devices and training techniques including tying, bending, topping, and other training techniques known in the art, the applicant has found that by intentionally placing a weight or a load onto the upper branches of the Cannabis plant in addition to certain training techniques, the plant vigour and growth is improved and horizontal growth of the branches is stimulated more effectively than the here before known methods of training and growing of Cannabis plants.

The applicant has also found that by cutting the upper most leaves which are closest to the apical meristem of the plant, results in the plant producing upper branches which often times are oriented equally around the upper canopy or top of the plant. In other words, three and more often four branches emanate after cutting the upper most leaves and these four branches are often oriented along north, south, east, west directions creating a cross configuration.

Additionally, placing a load or a weight onto the top of the upper most branches causes the plant to grow vigorously and quickly and develop a flat lateral/horizontal growth of the upper most branches. The weight is placed upon the branches as soon as they are able to support the weight without breaking the uppermost branches.

The weight and or load that is placed on the upper most branches is beneficially distributed across the top of the plant in the form of a screen having a lattice with small and potentially large openings which allow light to pass through which aid in ensuring the branches grow laterally or horizontally outwardly along the bottom of the screen or lattice.

Finally if necessary the upper most branches are manually positioned along the bottom of the screen such that they extend away from the apical meristem.

The present concept is a method of growing a Cannabis plant and includes the steps namely;
a) grow a main stem which is known as an apical meristem of a Cannabis plant to a height of 12 to 24 inches above the soil;
b) train the plant by trimming uppermost leaves of the apical meristem which results in the growth of at least three main upper branches emerging proximate the top of the plant;
c) apply a light cycle to stimulate a vegetative growth phase;
d) lower a screen onto the upper branches such that the upper branches support the weight of the screen, wherein applying the weight of the screen onto the upper branches increases the vigor of the plant and trains the branches to grow horizontally radially outwardly from the apical meristem.

Preferably further including the step;

manually position branches under the screen so that the branches are directed radially away from the apical meristem along a screen bottom surface and towards an outer periphery of the screen.

Preferably wherein step b) is replaced with step b′) as follows:
b′) train the plant by topping the plant by pruning the upper most part of the apical meristem which results in at least two main upper branches emerging proximate the top of the plant.

Preferably further comprising the step: allow growth to continue until branches extend to the outer periphery of a screen.

Preferably further comprising the step: apply a light cycle to stimulate reproductive growth phase to produce buds.

Preferably further comprising the step: remove the screen and harvest the buds.

Preferably wherein the screen is a made from a light translucent material allowing at least some light to pass through the screen and reach the Cannabis plant.

Preferably wherein the screen is made from a light transparent material allowing light to pass through the screen and reach the Cannabis plant.

Preferably wherein the screen per plant has a weight selected to be between 2 and 25 ounces.

Preferably wherein the screen per plant preferably has a weight selected to be between 8 and 12 ounces.

Preferably wherein the screen is configured for placement onto and off of the upper branches of the Cannabis plant.

Preferably wherein the screen includes a lattice work with numerous small and large lattice openings.

Preferably wherein the screen includes a lattice work with numerous small lattice openings of ⅜″ to 1½″ square in size which equates to 0.14 to 2.25 square inches of each small opening area.

Preferably wherein the screen includes a lattice work with numerous large lattice openings of between 1.25 to 2.25″ square which equates to 1.56 to 5.06 square inches of each large opening area.

Preferably wherein the small lattice openings can take on any shape each having 0.14 to 2.25 square inches of small opening area.

Preferably wherein the large lattice openings can take on any shape each having 1.56 to 5.06 square inches of large opening area.

### BRIEF DESCRIPTION OF THE DRAWINGS

With the intention of providing demonstration of characteristics of the device or method, an example or examples are given below without restrictive character whatsoever with reverence to the corresponding figures of preferred embodiments of the device and method as follows:

FIG. 1 is a schematic top plan view of a screen.

FIG. 2 is a schematic top perspective view of a screen showing FIG. 1.

FIG. 3 is a schematic top plan view of an alternate embodiment of the screen.

FIG. 4 is a top perspective view of the screen shown in FIG. 3.

FIG. 5 is a schematic side elevational view of a Cannabis plant shown together with a scale for indicating the height of the plant together with a screen placed onto the upper branches.

FIG. 6 is a schematic bottom perspective view of the plant shown in FIG. 5.

FIG. 7 is a schematic side elevational view of a Cannabis plant showing a more advanced stage of growth than in FIG. 5 where in the upper branches are growing laterally horizontally along the bottom of the screen.

FIG. 8 is a schematic side elevational view of a Cannabis plant shown at a later stage of growth than either FIGS. 5 and 7 where the plant has matured to the point where there is a large amount of horizontal and lateral growth along the bottom of the screen and the plant has entered into the reproductive phase with the appearance of buds.

FIG. 9 is a schematic bottom perspective view of the plant shown in FIG. 8.

FIG. 10 is a top schematic perspective view with some growth protruding through some of the openings in the lattice at a fairly early stage in the growth or the vegetative phase of the plant.

FIG. 11 is a schematic top perspective view of the screen lattice showing larger amounts of growth protruding through the openings in the lattice which represents a later stage in the development of the plant.

FIG. 12 is a top schematic perspective view of a screen shown suspended by some hooks and rope and pulley system which allows the screen to be lifted and lowered. The reader will note that a great deal of growth is protruding through the lattice openings of the screen in an advanced stage of the vegetative phase of the plant.

FIG. 13 is a flow chart describing the screen application process for the method for growing a Cannabis plant.

### DETAILED DESCRIPTION OF THE PREFERRED EMBODIMENTS

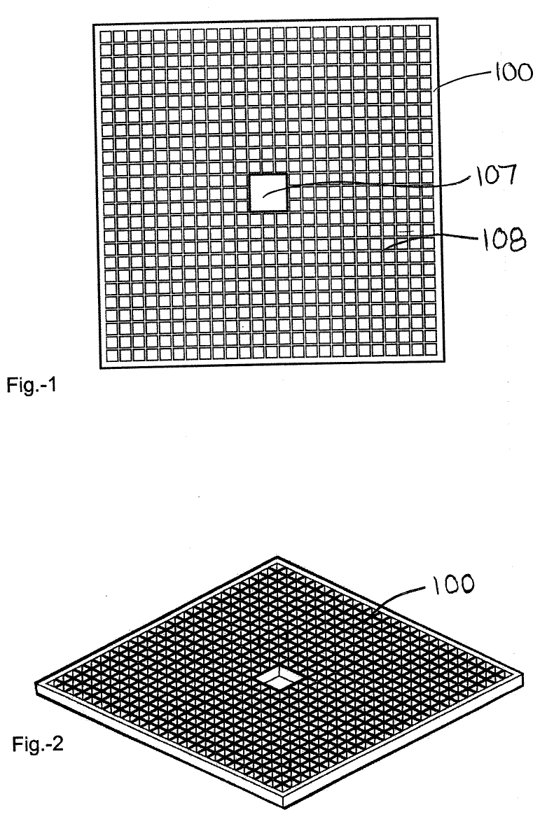

The present concept is a method and apparatus for growing a Cannabis plant and includes a device for applying a load or weight onto the top of the canopy of the Cannabis plant which preferably is a screen shown generally as 100 in FIG. 1 which is a lattice work which includes a centre hole 107 and small openings 108. Screen 100 is also shown in FIG. 2 in perspective view.

The lattice small opening 108 size in the best case scenario are about ½ to ¾ on an inch square but in practice anywhere from ⅜″ square to 1½ inches would also be acceptable. The centre hole measures about 1.75″ square but can range from 1.25 to 2.25″ square.

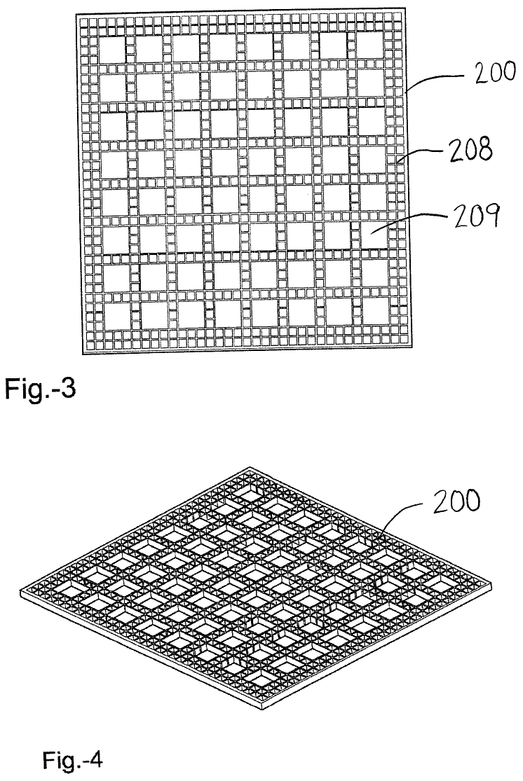

An alternate embodiment of the screen 200 is a lattice work having alternating small lattice openings 208 and large openings 209 throughout the lattice work as shown is shown in FIGS. 3 and 4 namely screen 200 having small lattice openings 208 and large openings 209. The small lattice openings 208 size in the best case scenario are about ½ to ¾ on an inch square but in practice anywhere from ⅜″ square to 1½ inches would also be acceptable. This is equivalent to 0.14 to 2.25 square inches of small opening area. The large openings 209 measure about 1.5″ to 1.75″ square but in practice can range from 1.25 to 2.25″ square. This is equivalent to 1.56 to 5.06 square inches of large opening area. The small and large openings could be other shapes such as for example round having a diameter which produces a similar area opening as the square openings.

The large openings allow a bud to project partially or fully there through thereby maximizing the light received by the bud. For a single plant the square screen 100 or 200 measures about 16″ to 30″ along one side of its four outer edges at the outer periphery and on average a screen size of 21″ to 24″ square works well. In the case of a round screen a diameter of 16″ to 30″ measured to its outer periphery works well with preferably a 21″ to 24″ diameter screen is used most frequently in practice. Other shapes are also possible especially when multiple plants are covered with one screen. In this example one screen per plant is used however the same technique is applicable for multiple plants under a larger screen which may be rectangular for example such as in a row of plants.

Both screens 100 and 200 are preferably made of translucent or transparent plastic material which allows the penetration of the light through the lattice and also through the openings within the screen.

Screen 100 is generally a smaller screen and weighs anywhere from 2 to 10 ounces in weight where as screen 200 which is more often used in the later stages of the vegetative growth phase and into the reproductive growth phase is normally heavier anywhere from approximately 5 to about 25 ounces in weight. Both of these screens are designed to evenly distribute the weight onto the upper branches and allow maximum penetration of artificial lighting lamp light through the lattice of the screens by either using translucent plastic material or transparent plastic material for the manufacture of the lattice of the screen in addition to the openings. There are large openings, particularly in screen 200 to allow for the light passage there through. There are other materials that may also be equally as effective, however from a cost benefit point of view the use of plastic material is preferred at the present time. Plastic light diffusers which are placed in front of overhead florescent tubes are a good source for use as screens in the present application.

The weight placed upon the plant is critical to enhance vigor and strength of the plant which results in a superior harvest. Less than 2 ounces in a young plant between about 12 and 20 inches in height is ineffective and less than 4 ounces on a large plant above about 20 inches in height is ineffective. The upper limit was found to be about 25 ounces above which does not result in any further improved results.

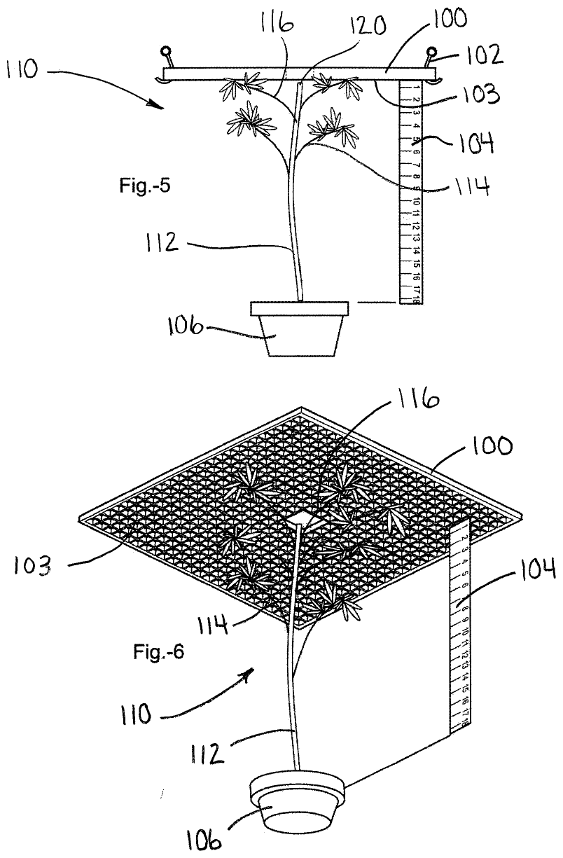

Referring now to FIG. 5 which shows a Cannabis plant 110 which has been transplanted into pot 106 from a seedling and has a main stem 112, lower branches 114, upper branches 116. There is a scale 104 on the side showing a vertical height of approximately 18 inches from the top of the pot to the bottom of the screen 100 which is positioned by hooks 102. The vertical height may range from 12 to 22 inches at this stage. This plant would have undergone some training which may include topping of top 120 and or as described earlier cutting of the upper most leaves which are closest to top of the apical meristem of the plant to induce the formation of four laterally horizontally extending upper branches 116 which are trained to grow along the bottom surface 103 or screen 100.

Screen 100 is placed onto the upper branches 116 and the weight of screen 100 is held aloft by the Cannabis plant 110 and not by any other means. Hooks 202 are used to lower the screen onto the plant and position screen 100.

FIG. 6 is a bottom perspective view of the Cannabis plant shown in FIG. 5 where in the reader can see that the upper branches are beginning to grow laterally and or horizontally along the bottom surface 103 of screen 100.

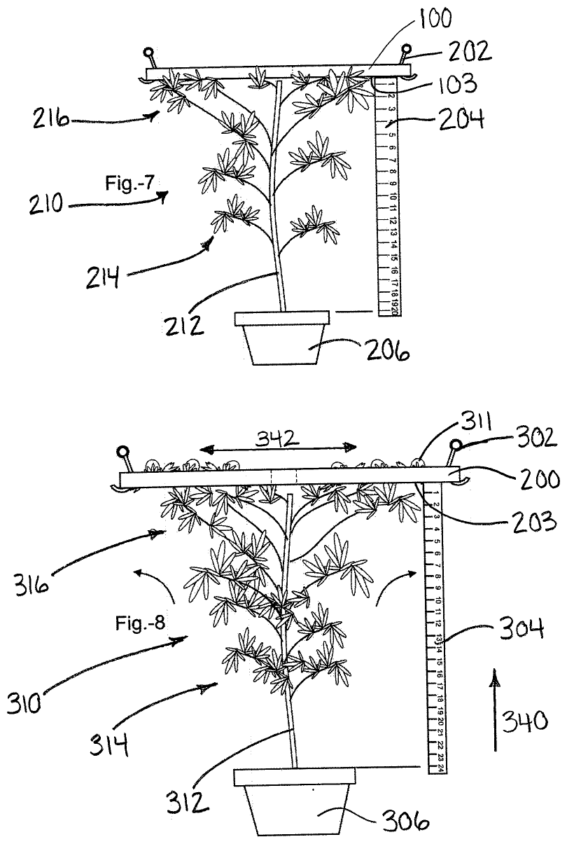

FIG. 7 is a schematic side elevational view of a Cannabis plant shown at a later stage of development than FIG. 5 where in the upper branches continue to grow laterally horizontally along the bottom surface 103 of screen 100 and this Cannabis plant 210 includes lower branches 214, upper branches 216, pot 206, a main stem 212, hooks 202, and a scale 204. The reader will note that the plant has a height from the top of the pot to the bottom surface 103 of the screen of approximately 20 inches. The height may vary from about 16 inches to 36 inches.

FIG. 8 is a schematic side elevational view of a plant which is again further along the vegetative phase than either FIG. 7 and or FIG. 5 and in addition it has sprouted buds 311 which begin to protrude through the large openings 209 of screen 200. Screen 200 generally speaking is larger and heavier than screen 100 and as indicated above can weigh anywhere from 5 to 25 ounces. Cannabis plant 310 shown in FIG. 8 includes lower branches 314, upper branches 316, stem 312, pot 306, scale 304 which the reader will notice that the plant is now approximately 24 inches in total height. The Figure also depicts lateral direction 342, vertical direction 340, and includes hooks 302, screen 200, and a bottom surface 203.

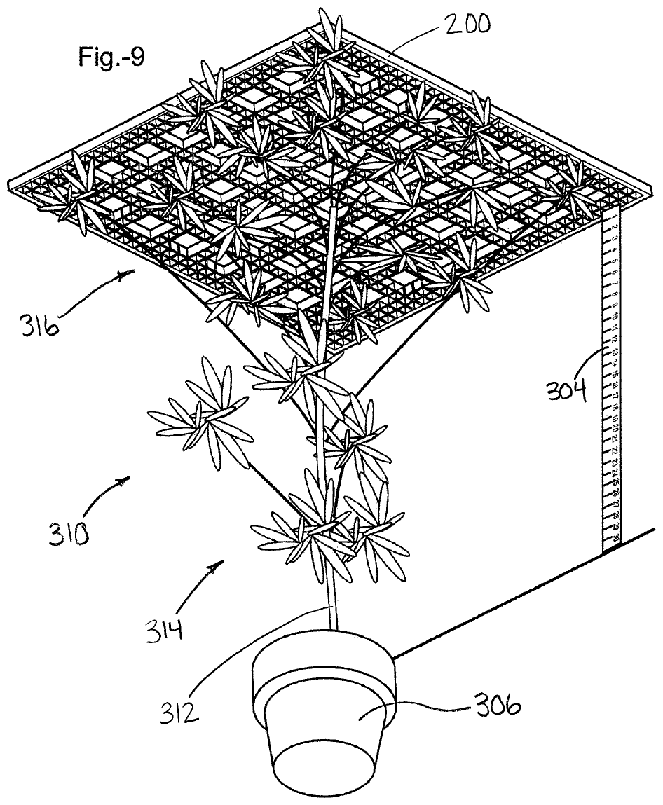

FIG. 9 is a bottom perspective view of the Cannabis plant 310 shown in FIG. 8.

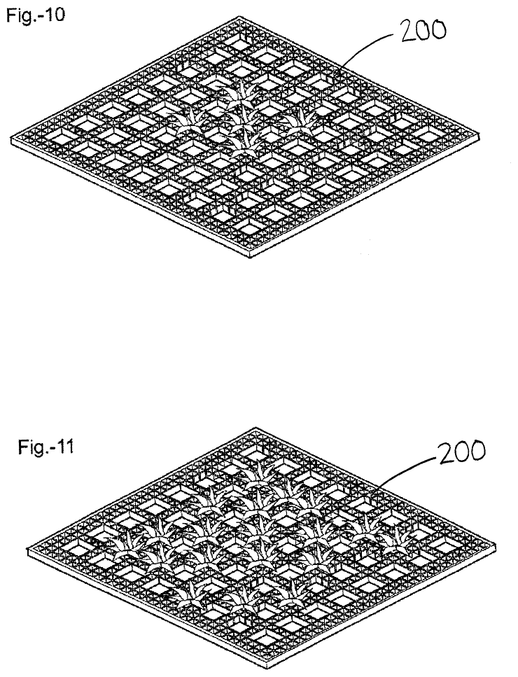

FIG. 10 is a top perspective view showing some of the plant growth in the early vegetative phase protruding through the openings 209 of screen 200.

FIG. 11 is showing more plant growth in a later part of the vegetative phase than FIG. 10 protruding through the openings 209 of screen 208 and is at a later stage of growth than FIG. 10.

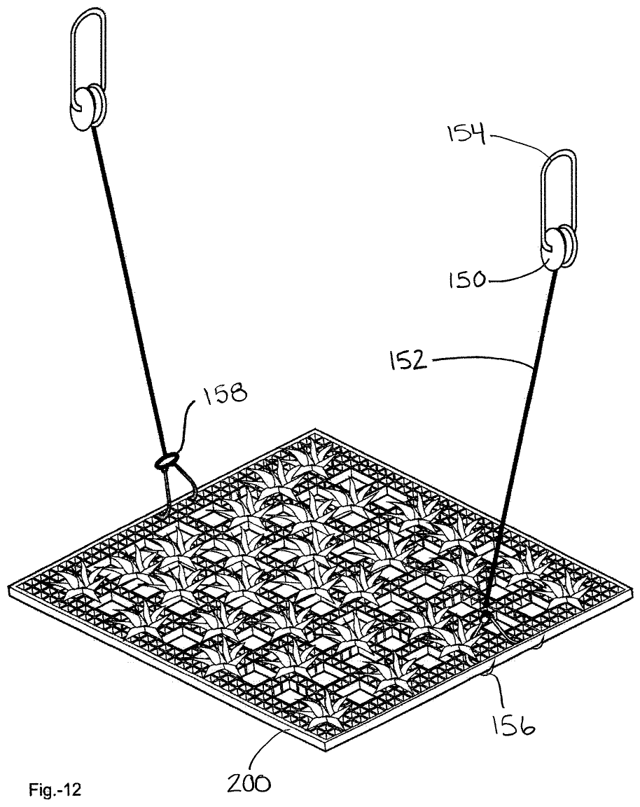

FIG. 12 shows yet further protrusion of growth through openings 209 of screen 200 where in the plant is developed to the point where the upper branches are extending laterally outwardly to almost the outer periphery of screen 200.

FIG. 12 additionally shows the apparatus used for raising and lowering the screen onto the plant namely a pair of pulleys 150 which are supported by support 154 and utilize rope 152 which are attached to lifting hooks 156 via a ring 158.

This diagram is schematic in nature in that it does not provide the details for how the pulley system operates however these details are well known in the art and can include any number of pulleys 150 which may include automatic retracting devices and may in fact be some sort of method of spooling the rope within the pulley or may include some other locking mechanisms for the rope as the screen 200 is either raised or lowered.

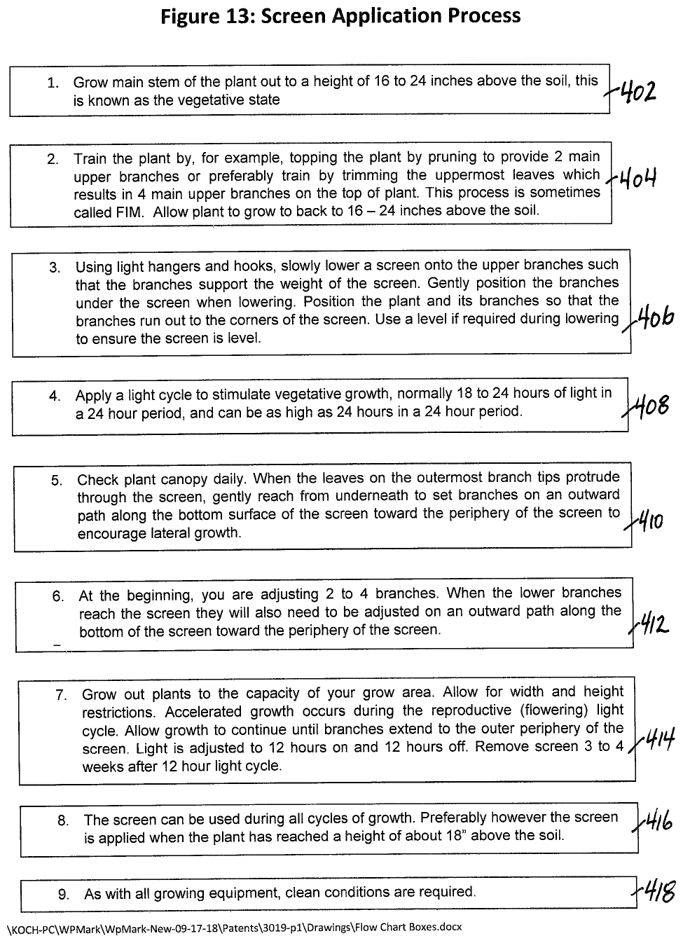

The method for growing a Cannabis plant and in particular the screen application process is described in FIG. 13 as follows:

Grow out the main stem of the plant out to a height of 16 to 24 inches above the soil which is known as the vegetative state and shown as box 402.

Train the plant by for example topping the plant by pruning to provide two main upper branches or preferably train by trimming the upper most leaves which results in four main branches on the top of the plant. Allow the plant to grow up to 16 to 24 inches above the soil shown as box 404.

Using light hangers and hooks, slowly lower a screen onto the upper branches such that the branches support the weight of the screen. Gently position the branches under the screen when lowering. Position the plant and its branches so that the branches run out to the corners of the screen. Use a level if required during lowering to ensure the screen is level shown as box 406.

Apply a light cycle to stimulate vegetative growth or the vegetative stage which normally is at least 18 hours of light on in a 24 hour period and can be as high as 24 hours of light in a 24 hour period as shown as box 408.

Check plant's canopy daily. When the leaves on the outer most branch tops protrude through the screen, gently reach from underneath to set branches on an outward path along the bottom of the screen toward the periphery of the screen to encourage lateral growth shown as in box 410.

At the beginning you will be adjusting two to four branches. When the lower branches reach the screen, they will also be adjusted on an outward path along the bottom surface of the screen toward the periphery of the screen shown as box 412.

Grow plants to the capacity of your grow area. Allow for width and height restrictions. Accelerated growth occurs during the reproductive phase or sometimes referred to as the flowering phase. Allow growth to continue until branches enter the extent to the outer periphery of the screen. During the reproductive or flowing phase, the light is normally timed for 12 hours on time and 12 hours of off time which shows as box 414.

The screen can be used during all cycles of growth, however preferably, the screen is applied when the plant has reached a height of about 18 inches above the soil shown as box 416.

As with all growing equipment clean conditions are required shown as box 418.

I claim:

1. A method of growing a Cannabis plant includes the steps;
e) grow a main stem which is known as an apical meristem of a Cannabis plant to a height of 12 to 24 inches above the soil;
f) train the plant by trimming uppermost leaves of the apical meristem which results in the growth of at least three main upper branches emerging proximate the top of the plant;
g) apply a light cycle to stimulate a vegetative growth phase;
h) lower a screen onto the upper branches such that the upper branches support the weight of the screen, wherein applying the weight of the screen onto the upper branches increases the vigor of the plant and trains the branches to grow horizontally radially outwardly from the apical meristem.

2. The method of growing a Cannabis plant as claimed in claim 1, further including the step;
manually position branches under the screen so that the branches are directed radially away from the apical meristem along a screen bottom surface and towards an outer periphery of the screen.

3. The method of growing a Cannabis plant as claimed in claim 1, wherein step b) is replaced with step b′) as follows:
b′) train the plant by topping the plant by pruning the upper most part of the apical meristem which results in at least two main upper branches emerging proximate the top of the plant.

4. The method of growing a Cannabis plant as claimed in claim 1, further comprising the step:
allow growth to continue until branches extend to the outer periphery of a screen.

5. The method of growing a Cannabis plant as claimed in claim 1, further comprising the step:
apply a light cycle to stimulate reproductive growth phase to produce buds.

6. The method of growing a Cannabis plant as claimed in claim 5, further comprising the step:
remove the screen and harvest the buds.

7. The method of growing a Cannabis plant as claimed in claim 1, wherein the screen is a made from a light translucent material allowing at least some light to pass through the screen and reach the Cannabis plant.

8. The method of growing a Cannabis plant as claimed in claim 1, wherein the screen is made from a light transparent material allowing light to pass through the screen and reach the Cannabis plant.

9. The method of growing a Cannabis plant as claimed in claim 1, wherein the screen per plant has a weight selected to be between 2 and 25 ounces.

10. The method of growing a Cannabis plant as claimed in claim 1, wherein the screen per plant preferably has a weight selected to be between 8 and 12 ounces.

11. The method of growing a Cannabis plant as claimed in claim 1, wherein the screen is configured for placement onto and off of the upper branches of the Cannabis plant.

12. The method of growing a Cannabis plant as claimed in claim 1, wherein the screen includes a lattice work with numerous small and large lattice openings.

13. The method of growing a Cannabis plant as claimed in claim 1, wherein the screen includes a lattice work with numerous small lattice openings of ⅜″ to 1½″ square in size which equates to 0.14 to 2.25 square inches of each small opening area.

14. The method of growing a Cannabis plant as claimed in claim 1, wherein the screen includes a lattice work with numerous large lattice openings of between 1.25 to 2.25″ square which equates to 1.56 to 5.06 square inches of each large opening area.

15. The method of growing a Cannabis plant as claimed in claim 12, wherein the small lattice openings can take on any shape each having 0.14 to 2.25 square inches of small opening area.

16. The method of growing a Cannabis plant as claimed in claim 12, wherein the large lattice openings can take on any shape each having 1.56 to 5.06 square inches of large opening area.
